(19) United States
(12) Patent Application Publication
(10) Pub. No.: US 2017/0337521 A1
(43) Pub. Date: Nov. 23, 2017

(54) SYSTEMS AND METHODS FOR CREATING PERFORMANCES AND EVENTS VIA A SOCIAL NETWORKING PLATFORM

(71) Applicant: Eventscoop Inc., San Francisco, CA (US)

(72) Inventors: Lalita S. GODBOLE, San Jose, CA (US); Aditya S. GODBOLE, San Francisco, CA (US)

(21) Appl. No.: 15/598,421

(22) Filed: May 18, 2017

Related U.S. Application Data
(60) Provisional application No. 62/392,133, filed on May 23, 2016.

(51) Int. Cl. G06Q 10/10; G06Q 50/00; G06Q 10/02

(52) U.S. Cl. CPC G06Q 10/1095; G06Q 10/02; G06Q 50/01

(57) ABSTRACT

Event creation systems and methods implemented on a server hosting an event application include receiving a request for an event and a pledge for the event from a first user, wherein subsequent to the request, the event is defined by a type of event, a specified date or range of dates, a geography, and a minimum support threshold; receiving pledges from a plurality of additional users over a specified timeline prior to the specified date or range of dates; subsequent to the pledges exceeding the minimum support threshold, obtaining confirmation from event contributors required for the event and a venue for holding the event; and, subsequent to the confirmation from the event contributors and the venue, converting the pledge from the first user and the pledges from the plurality of additional users into confirmed tickets for the event.

### CROSS-REFERENCE TO RELATED APPLICATION(S)

The present patent/application claims priority to U.S. Provisional Patent Application No. 62/392,133, filed May 23, 2016, and entitled “METHODS AND SYSTEMS FOR CREATING A USER INITIATED DEMAND GENERATION SOCIAL NETWORKING PLATFORM FOR CREATING PERFORMANCES AND EVENTS,” the contents of which are incorporated by reference herein.

### FIELD OF THE DISCLOSURE

The present disclosure generally relates to event planning systems and methods. More particularly, the present disclosure relates to systems and methods for creating performances and events and estimating demand via a social networking platform.

### BACKGROUND OF THE DISCLOSURE

Conventional performance and event planning is driven by promoters not the attendees, i.e., the fans. Performances and events can include concerts, performance arts, charity events, festivals, dances, community drives, etc. In the conventional approach, a promoter is responsible for choosing the artist, act, etc., scheduling a venue, and marketing and selling tickets. Of course, this approach works well for established acts, performances, etc. which sell out or sell enough tickets so that the promoter covers the costs. However, this is a top-down approach where the promoters are responsible. Specifically, attendees, fans, users, etc. are mere participants and simply purchase tickets to already planned events. This approach does not work well with up and coming acts or with diehard fans who want to bring an event to life. A fan does not want to become a promoter as there is underlying risk—will enough tickets be sold to cover the costs? An up and coming act has to typically play clubs or other venues with little or no promotion and very little share of proceeds. That is, the conventional event planning paradigm is top down and includes economic risk. With the proliferation of social networking platforms, it would be advantageous to provide a bottom-up approach where fans initiate and cause events to happen.

### BRIEF SUMMARY OF THE DISCLOSURE

In an exemplary embodiment, an event creation method implemented on a server hosting an event application includes receiving a request for an event and a pledge for the event from a first user, wherein subsequent to the request, the event is defined by a type of event, a specified date or range of dates, a geography, and a minimum support threshold; receiving pledges from a plurality of additional users over a specified timeline prior to the specified date or range of dates; subsequent to the pledges exceeding the minimum support threshold, obtaining confirmation from event contributors required for the event and a venue for holding the event; and, subsequent to the confirmation from the event contributors and the venue, converting the pledge from the first user and the pledges from the plurality of additional users into confirmed tickets for the event. The event creation method can further include, subsequent to the request, providing notification to the plurality of additional users via one or more social networking platforms. The event creation method can further include, subsequent to the confirmation from event contributors and the venue, providing tickets to a second additional plurality of users for the event.

The event can include any of a musical performance, an act, an art exhibit, a sporting event, a culinary event, and a social gathering. The event creation method can further include, subsequent to the any of a failure to meet the minimum support threshold and a failure of the confirmation from event contributors and the venue, canceling the event and either not converting the pledges into actual charges or refunding the pledges. The minimum support threshold can be defined as an amount required to cover costs of the venue and the event contributors. The minimum support threshold can be defined as an amount close to costs of the venue and the event contributors. The event application can be incorporated in or connected to a social networking platform, and wherein the first user and the plurality of additional users access the event application via one or more of a browser and an application executed on a user device.

The event can be managed by the event application in three stages including a hopeful stage subsequent to the request and prior to the minimum support threshold, a confirmation pending stage subsequent to the minimum support threshold and prior to the confirmation from the event contributors and the venue, and a confirmed event subsequent to the confirmation from the event contributors and the venue. The venue can be selected based on a request process involving a plurality of venues, the first user, the plurality of additional users, and the event contributors. The event creation method can further include receiving pledges from a plurality of professional users including advertisers, event organizers, and vendors that want to sell goods at the event over a specified timeline prior to the specified date or range of dates.

In another exemplary embodiment, a server executing an event application for event creation by users includes a network interface communicatively coupled to the Internet; one or more processors communicatively to the network interface; and memory storing instructions that, when executed, cause the one or more processors to receive a request for an event and a pledge for the event from a first user, wherein subsequent to the request, the event is defined by a type of event, a specified date or range of dates, a geography, and a minimum support threshold; receive pledges from a plurality of additional users over a specified timeline prior to the specified date or range of dates; subsequent to the pledges exceeding the minimum support threshold, obtain confirmation from event contributors required for the event and a venue for holding the event; and, subsequent to the confirmation from event contributors and the venue, convert the pledge from the first user and the pledges from the plurality of additional users into confirmed tickets for the event.

The memory storing instructions that, when executed, can further cause the one or more processors to, subsequent to the request, provide notification to the plurality of additional users via one or more social networking platforms. The memory storing instructions that, when executed, can further cause the one or more processors to, subsequent to the confirmation from event contributors and the venue, provide tickets to a second additional plurality of users for the event. The event can include any of a musical performance, an act, an art exhibit, a sporting event, a culinary event, and a social gathering. The memory storing instructions that, when executed, can further cause the one or more processors to, subsequent to the any of a failure to meet the minimum support threshold and a failure of the confirmation from event contributors and the venue, cancel the event and either not converting the pledges into actual charges or refunding the pledges.

The minimum support threshold can be defined as an amount required to cover costs of the venue and the event contributors. The minimum support threshold can be defined as an amount close to costs of the venue and the event contributors. The event application can be incorporated in or connected to a social networking platform, and wherein the first user and the plurality of additional users access the event application via one or more of a browser and an application executed on a user device. The event can be managed by the event application in three stages including a hopeful stage subsequent to the request and prior to the minimum support threshold, a confirmation pending stage subsequent to the minimum support threshold and prior to the confirmation from the event contributors and the venue, and a confirmed event subsequent to the confirmation from the event contributors and the venue.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a diagram of a first stage of an event creation process with the creation of an event request;

FIG. 2 is a diagram of the event creation process with an exemplary Graphical User Interface (GUI) for the user to create the event;

FIG. 3 is a diagram of a second stage of the event creation process subsequent to creation of the event request in the first stage;

FIG. 4 is a diagram of a third stage of the event creation process subsequent to the event request in the first stage, and the event confirmation is the second stage;

FIG. 5 is a diagram of Graphical User Interface (GUI) of a geographical area listing events including hopeful (drives) and confirmed events;

FIG. 6 is a screen shot for requesting an artist;

FIG. 7 is a screen shot for requesting an event;

FIG. 8 is a screen shot for browsing through current drives, events pending confirmation, and confirmed events;

FIG. 9 is a screen shot for requesting an artist;

FIG. 10 is a screen shot subsequent to a request in FIG. 9 to confirm an event request;

FIG. 11 is a screen shot of reserving tickets, i.e., making a pledge to a drive;

FIG. 12 is a screen shot for sharing a newly created drive with friends via the social networking platform or other social media;

FIG. 13 is a screen shot showing a status of a drive;

FIG. 14 is a screen shot for pledging support to the drive;

FIG. 15 is a screen shot for reserving tickets for a drive;

FIG. 16 is a screen shot of feature drives;

FIG. 17 is a screen shot for browsing current drives, events pending confirmation, and confirmed events by category;

FIG. 18 is a screen shot for browsing current drives, events pending confirmation, and confirmed events by location;

FIG. 19 is a block diagram of a server which may be used to host the social networking platform, the event application, etc.;

FIG. 20 is a block diagram of a user device which may be used to access the social networking platform 12, the event application, etc.; and

FIG. 21 is a flowchart of an event creation process implemented on the server hosting an event application.

### DETAILED DESCRIPTION OF THE DISCLOSURE

Again, in various exemplary embodiments, the present disclosure relates to systems and methods for creating performances and events via a social networking platform. The systems and methods empower users of a social networking platform to initiate, create demand, and support a request for an event of any type. That is, the systems and methods turn event planning from the conventional top-down approach where promoters, artists, and venues plan the event to a bottom-up approach where the fans are the ones initiating the events. This process is only enabled through the social networking platform, which allows fans to connect to one another, create events, support events, and the like. The platform allows users to request the creation of an event by certain identified event professionals or a general request for events of a specified category in a specified geography and a specified time period. The user can then make a monetary pledge, which will be converted to a confirmed ticket for the event if the event achieves a threshold of committed supporters and the request for the event is converted to a real event.

In a more general form, the platform enables a user to initiate an event that would be supported by a community of individuals by pre-creating a backed monetary demand for the event to be initiated. The user can be an individual, a machine, an organization, a community, a group, or any other entity that has the authority to pledge a monetary amount. The event, in its most general form, could be a musical performance, an act, a painting, a sport event, a culinary event, a social gathering, or any other event that require certain monetary investment for its occurrence. The artist or performer, in its most general form, can be an individual performer, a group, an organization, or any other professional that renders services that enable the event to occur. Advantageously, the systems and methods enable fans to take control and be the ones responsible for creating events. In this manner, bands, acts, performers, events, etc. can be set up. Importantly, the systems and methods enable events to be set up without risk since no capital expenditures are required until the proposed event has a threshold number of attendees with associated monetary pledges.

Advantageously, the systems and methods democratize event creation. That is, any event a user can think of could be planned using the systems and methods, as long as the threshold monetary pledge is achieved. The systems and methods can be implemented through a social network platform executed on one or more servers in the cloud and via browsers or apps on user devices. The users can interact with the social network platform through Graphical User Interfaces (GUIs) allowing the user to request a drive (a drive defined as a request for a potential event). The drive request starts a crowdfunding campaign to attract additional attendees (“fans”) as well as potential sponsors. The social networking platform can be used to spread the word to attract users and their monetary pledges. Once the monetary pledges reach a threshold, such as to cover the costs of the event, further logistics can occur via the platform to schedule and confirm the event with the users' who made pledges becoming ticketed for the event.

The objective is to empower users to bring the events they love to life such as to bring a favorite artist to town, to create a unique event to see how many people will attend, to plan private events with select users and to use the platform to cover the costs of the private events, etc. Again, the event creation is risk-free allowing a test drive before it becomes confirmed and it only becomes confirmed if the support is there. There are various use cases such as to discover events near and far, plan a weekend with friends, date night, see an artist or performer in your city/neighborhood, etc. The platform gives the user the power to demand an event at the user's choice. For example, if a user hears a jazz quartet play in a club in San Francisco and think it would be great if they played in the user's city. As a fan, the user could use the platform to express this desire to the artist. The platform helps a user request a performance in the city of choice, and back it up with a reservation that becomes a ticket to the future performance once confirmed. After the first reservation the platform promotes this Drive to other users of the platform and the general public using various marketing media and methods. With reservations from the initial user and other users, an artist and venue can see the demand for the event and commit to participate in the event. The platform then arranges a event organizer to help make it happen. If the drive does not raise the minimum number of reservations required to make it a success, no one gets charged. Thus, the platform is completely risk-free for both you the fan and the professionals to envision and realize events. The platform coordinates with the professionals to make the events a success. The possibilities for the kinds of events that can be demanded on the platform are limitless.

The platform also enables potential sponsors/advertisers to pledge monetary support for a proposed event to help the Drive reach its threshold amount. The platform identifies the events that can be supported solely through sponsorships, thus allowing for free admission to event attendees. For certain types of events, the platform collects monetary pledges from attendees as well as sponsorships from advertisers. The attendee pledges may then be refunded at the event in the form of reimbursable coupons etc. The platform provides an incentive system for sponsors by offering discounted pricing for early commitments.

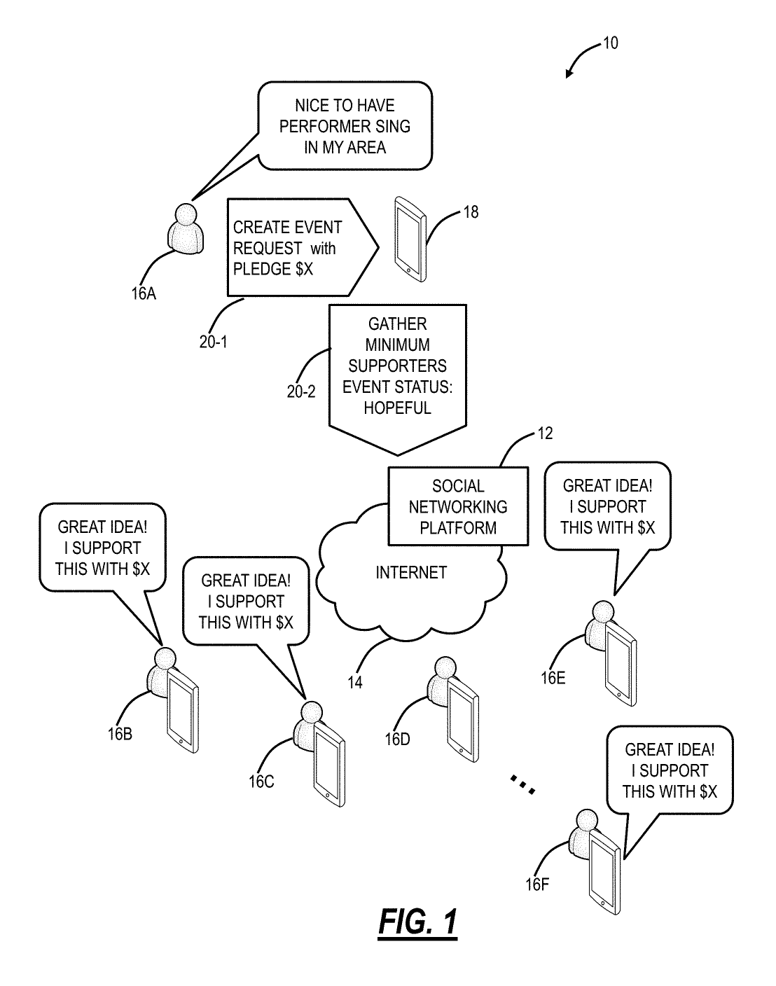

Referring to FIG. 1, in an exemplary embodiment, a diagram illustrates a first stage of an event creation process 10 with the creation of an event request. The event creation process 10 is implemented through a social networking platform 12, which is on or communicatively coupled to the Internet 14 or another network. The social networking platform 12 is implemented through one or more servers and accessed by users 16 over the Internet, such as on user devices 18 through an application (“app”), browser, etc. The systems and methods can be an application executed on the social networking platform 12, such as an event application. For example, the social networking platform 12 can be Facebook, Instagram, Linkedin, Twitter, Pinterest, email, etc. In another exemplary embodiment, the social networking platform 12 can be separate but connected to other social networking platforms to invite the users 16. The users 16 each have an associated user device 18 which can be a smartphone, a tablet, a laptop, an ultrabook, a desktop, etc. The user device 18 can include an app dedicated for the event creation process 10 or a Web browser. In either case, the app or browser can access the social networking platform 12 for implementing the various steps described herein.

The event creation process 10 begins with a user 16A of the social networking platform 12 thinking of an event they would like to attend/have in a certain geography in a certain time period. The user 16A uses the social networking platform 12 to create and set criteria for an event request associated with the event (step 20-1). For example, the user 16A pledges $X towards the event which would be converted to $X worth of tickets once the event is confirmed. Once completed by the user 16A, the event request is advertised on the social networking platform 12 to invite additional users 16B-16F to support and contribute to the request (step 20-2). The additional users 16B-16F can include more than the number shown and they can be alerted via the social networking platform 12, such as through email, timeline entries, messages, tweets, pop-ups, and the like. The additional users 16B-16F can select a Uniform Resource Locator (URL) or the like in the message to bring up another GUI for the additional users 16B-16F to enter their support via a corresponding pledge (e.g., I support this for Y tickets and/or with $X). Also, there can be rewards or incentives for the user 16A and/or for the additional users 16B-16F who are early supporters of the event, such as discounts, reward points, coupons, etc.

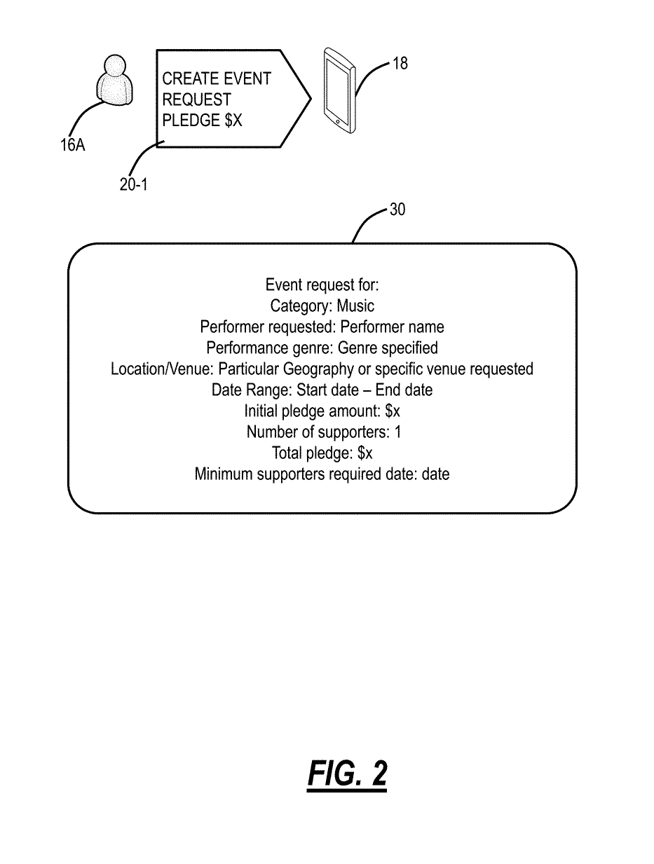

Referring to FIG. 2, in an exemplary embodiment, a diagram illustrates the event creation process 10 with an exemplary GUI 30 for the user 16A to create the event. The GUI 30 illustrates some criteria that may define an event request. The user 16A can input the criteria or select from predefined criteria using the GUI 30. The criteria are a set of information that defines the event and may include, for example, the desired performers for the event, a date range from the event, a geography where the event is requested (e.g., a city, neighborhood, zip code, etc.), a category/genre of event, a proposed venue, a pledge amount, a number of supporters required, a total pledge, incentives or rewards for early supporters, a current status, and the like.

The creator (the user 16A) and subsequent supporters (the additional users 16B-16F) are required to pledge the minimum amount set by the application for the requested artist and geography, in creating and further supporting the event request. These pledges are converted to event tickets if the event is successfully executed. Otherwise, the pledges are refunded after a ‘hopeful’ status period has ended. That is, the users 16A-16F can input payment such as via a Credit Card, Paypal, ACH transfer, etc. for a temporary charge or hold. The payment is either refunded or processed only when the event is confirmed. At the time of creation, an event request will be considered to be in a ‘hopeful’ state, indicating that, an artist and venue have not confirmed it and/or there are not enough users 16 pledged to recover the costs.

Once the event request is created, it is submitted to the event application and gets listed under the currently hopeful event requests section. The event application promotes the event requests to users who may be interested in it based on event application generated recommendation criteria. The promotion can be via the social networking platform 12, any other social media technique, or print media. The event application also enables the creator, supporters, and professionals associated with the event to market the event to their connections, other users of the event application and the general public.

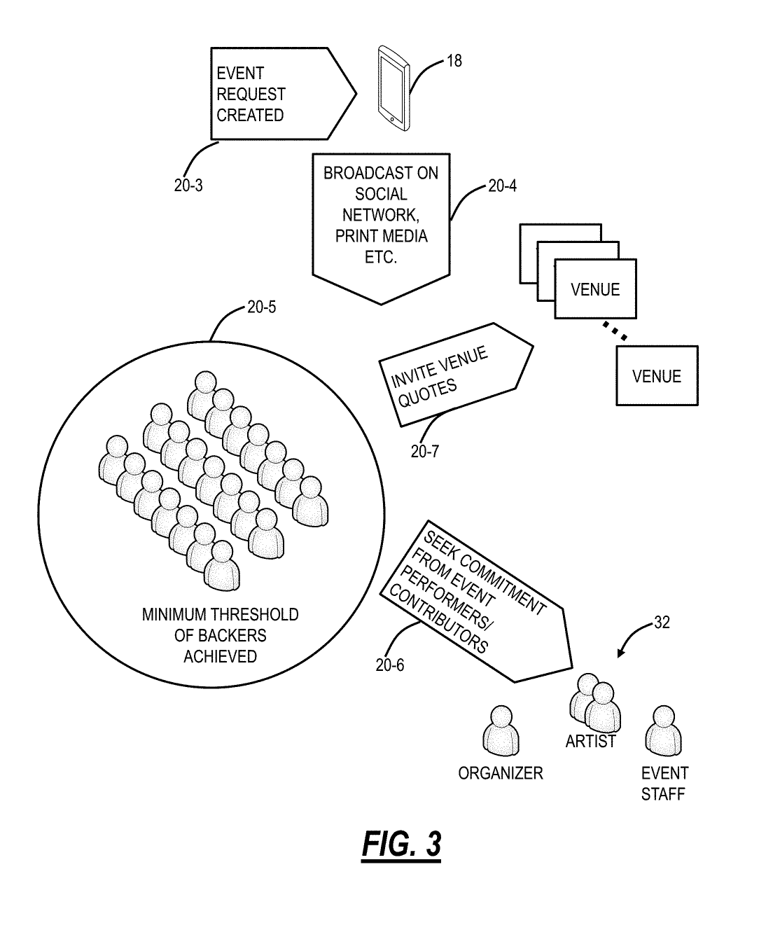

Referring to FIG. 3, in an exemplary embodiment, a diagram illustrates a second stage of the event creation process 10 subsequent to the creation of the event request in the first stage. After the event request is created by the user 16A (step 20-3), the event is broadcast on the social networking platform 12 and the like (step 20-4). The broadcast stage is for a set period of time, e.g., a week, a set number of days, etc. The broadcast can include various known techniques for notifying the additional users 16B-16F via various media. During the set period of time, the objective is to attract additional supporters and pledges from the additional users 16B-16F of the social networking platform 12 (step 20-5).

There is a minimum threshold of backers—either a number of users 16 including support from professional users like vendors and advertisers, and/or a set monetary amount. The minimum threshold of backers is key to the risk-free aspect of the event creation. The minimum threshold of backers is what is required for the event to break even, i.e., cover the costs of the venue, the artists, or any other costs associated with the event. The event request attracts additional supporters and pledges from users of the social networking platform 12. Once an application specified minimum threshold of supporters is achieved (step 20-5), the event application informs the artist and other event contributors 32 of the event request and seeks commitment to the event request criteria (step 20-6). As described herein, the event contributors 32 can be artists, organizers, event staff, performers, vendors, cooks, etc., i.e., anyone required for the event. If a specific venue is not specified in the event request, venues 34 in the specified geography are approached by the application to host the event (step 20-7). If a venue is specified, the venue is confirmed if available for the specified date or range of dates and the cost is covered. For example, various venues can have reservation fees, and a specified venue can be automatically reserved once the minimum threshold is met. Also, the venue can share a portion of ticket prices. Various approaches are contemplated. In another exemplary embodiment, if the venue is not explicitly specified, venues may request to host the event.

In the event creation stage, the event can be referred to as a “drive” or potential event. Here, the event is in the planning/formation stage requiring various commitments, managed via the social networking platform 12, prior to becoming a planned or confirmed event. The event is confirmed when i) the minimum number of pledged users is achieved, ii) the event contributors 32 confirm, and iii) a venue is confirmed. The first stage is the event creation stage where the number of pledges is acquired, and the second stage is the event confirmation.

FIG. 3 for the second stage captures the progression of the event request on the event application in its hopeful state. The event application defines the number of supporters required to meet the minimum threshold of support to transition the event request to the next state. In an exemplary embodiment, the supporters may or may not withdraw their pledge of support during the hopeful period (the period of time between the event request creation and meeting the minimum threshold).

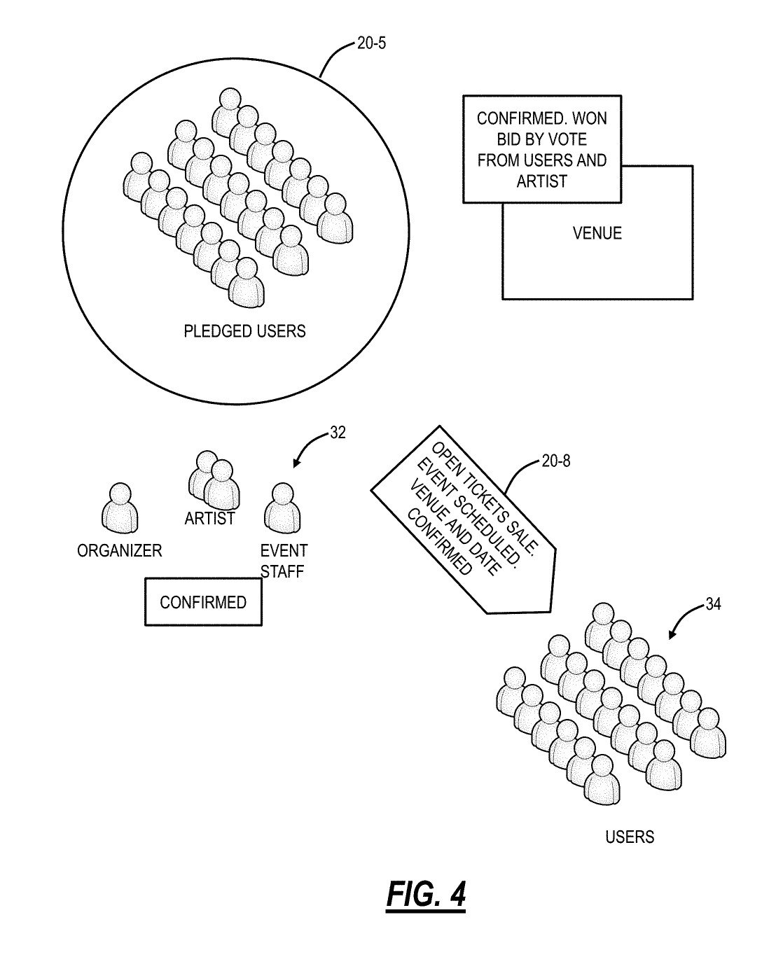

Referring to FIG. 4, in an exemplary embodiment, a diagram illustrates a third stage of the event creation process 10 subsequent to the event request in the first stage and the event confirmation is the second stage. At the third stage, the event is confirmed, from the second stage, with the pledged users from step 20-5 having their pledges converted to tickets for the event, with the event contributors 32 confirmed at step 20-6, and with the venue confirmed from step 20-7. Once the event request has received the threshold of support, the event request transitions to the next state, defined as “pending” by the event application. In this state, the event application notifies the requested artist and/or the event contributors 32 of the event request to seek confirmation within the requested event request criteria. If a venue is not specified, venues are requested to request to host the event.

The venue can be selected based on it being initially designated by the user 16A. In another exemplary embodiment, the venue can be selected based on a vote by the users 16 and/or the event contributors 32. The vote can be weighted, such as with the event contributors 32 having an equal or larger say than the users 16 or the other way with the users 16 having an equal or larger say than the event contributors 32. Alternatively, the venue can be selected based on a number of attendees, the specified geography, the cost, availability, etc. Further, the users 16 and/or the event contributors 32 can have a veto of the venue. Pledged supporters may or may not be requested to vote on venue requests and any feedback or change suggestions made by the artist/event performers. Once the event request has transitioned out of the hopeful state, removing the pledge of support may or may not have a processing charge. Optionally, the venues themselves can participate in a request process to hold the event. For example, the venue with maximum pledged user votes wins the request. The venue with the most votes or highest request or another criteria for selection wins the request, and once an agreement on date and time is achieved amongst parties via the application, the event request transitions to the next ‘confirmed’ state. Throughout this process, additional users may continue to pledge their support.

The pledged users can vote on the date proposed or confirmed by the artist, venue, and other event contributors. The date receiving maximum votes can be confirmed. The event request moves from a “hopeful” state to a “confirmed” state. Once the event, the date, and the event contributors 32 are confirmed, additional users 34 can buy a ticket to the event (step 20-8). Once the event is confirmed, the users 16 have their pledges converted to tickets and new users 34 do not have to pledge their support to the drive, but rather can simply buy a ticket.

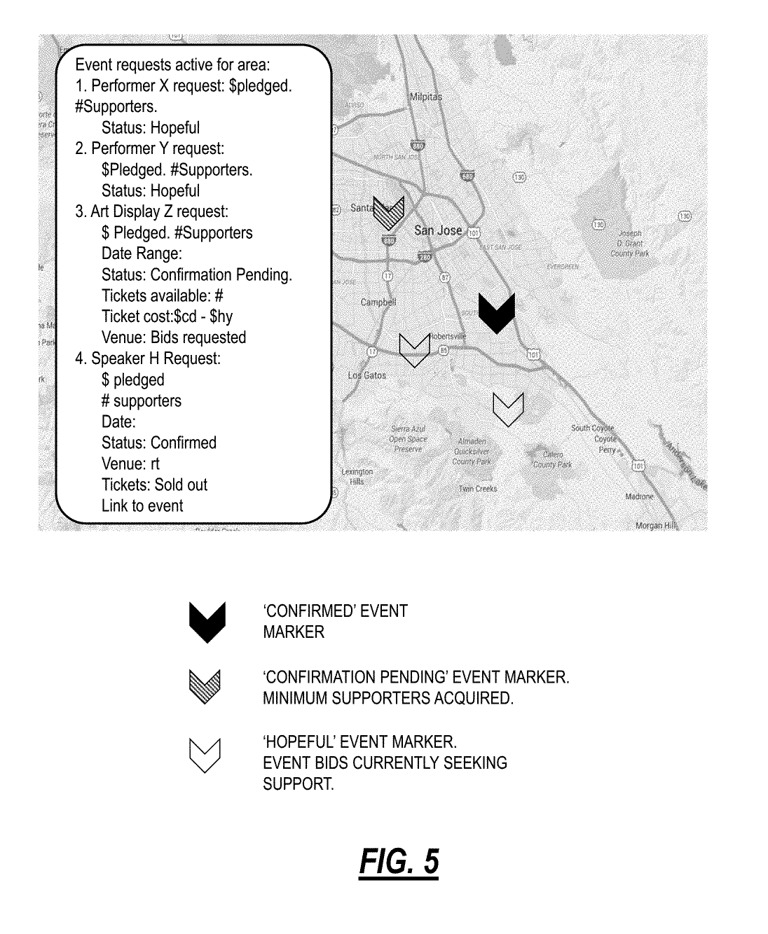

Referring to FIG. 5, in an exemplary embodiment, a diagram illustrates Graphical User Interface (GUI) of a geographical area listing events including hopeful (drives) and confirmed events. The event request is now a confirmed event after the third stage in FIG. 4. All events or drives can be listed on the GUI in the event application. As seen in FIG. 5, there can be markers for confirmed events (minimum support reached, venue and event contributors 32 confirmed), confirmation pending events (minimum support reached, awaiting venue and event contributors 32 confirmation), and hopeful events (drives) (awaiting minimum support). A user can purchase tickets for the confirmed events and pledge support for the confirmation pending events and hopeful events. Any remaining tickets besides the confirmed tickets to the pledged users are sold to the additional users 34 such as via the event application. The additional users 34 can simply buy a ticket, but they are precluded from the rewards received by early adopters.

The GUI in FIG. 5 can be displayed via the app or browser on the user device 18 allowing a user of the social networking platform 12 to browse for activities. The event request feature aims to empower users of the event application with the ability to create an event of their choice, generate support for the event, such that the event may be brought to fruition.

### Use Cases

The event application, the event creation process 10, and the social networking platform 12 contemplate various use cases to create virtually any type of event. In a first use case, a user may request a particular musician to perform in their city within a specified date range. The event will be brought to reality with the support of other users that are fans of the musician in the specified city.

In a second use case, a school may request a speaker for a school assembly. The school community, neighborhood or parent employers may support the request. In a third use case, a user may request for an artist's art display in a particular city. Users from the city and neighboring areas may support the request. In a fourth use case, a user may request an artist to perform at a particular venue. In a fifth use case, a user may request the screening of a particular movie in a particular city. In a sixth use case, a user may request artists playing a specified genre of music to perform in a specified area. In a seventh use case, a user may request a game between specified sports teams in a city. In an eighth use case, a user may request a specified speaker or category of the speaker to speak at a specified location and time. In a ninth use case, a user may request a charity event fundraiser to be organized by like-minded people for a supporting a specific cause in a general geographical area and a span of time. In a tenth use case, a user may request a specific type of food caterer or food truck to be present around a certain venue at lunchtime. Those skilled in the art will recognize various other use cases are also contemplated.

### Event Application Screen Shots

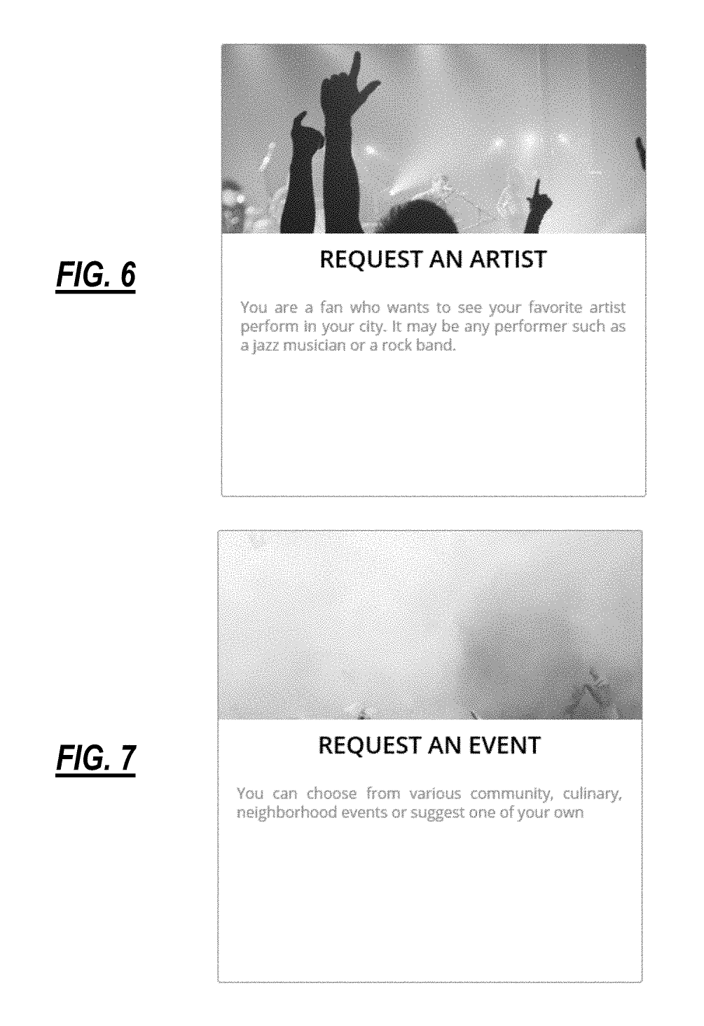

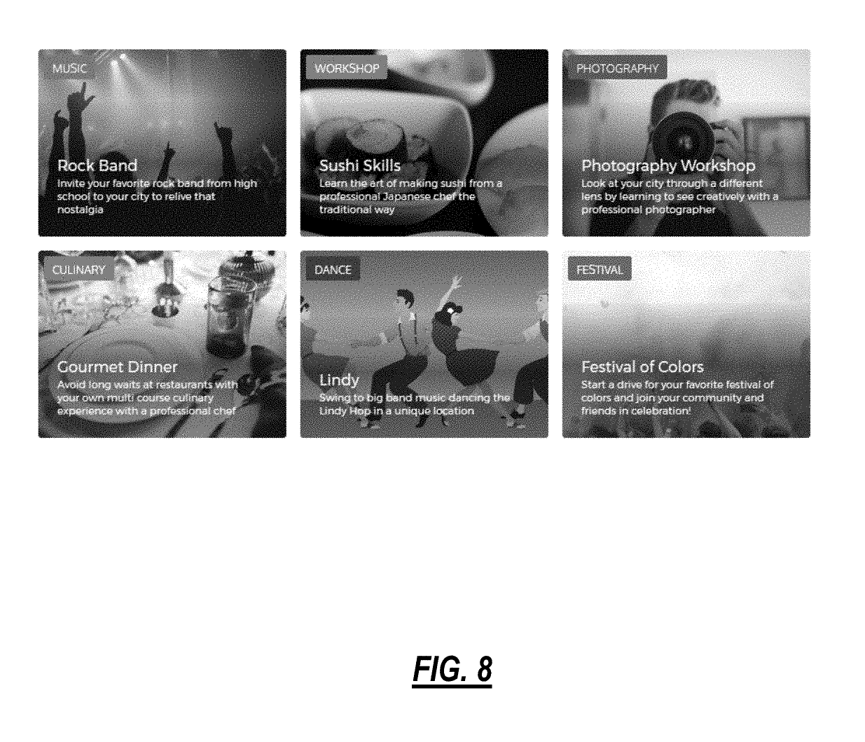

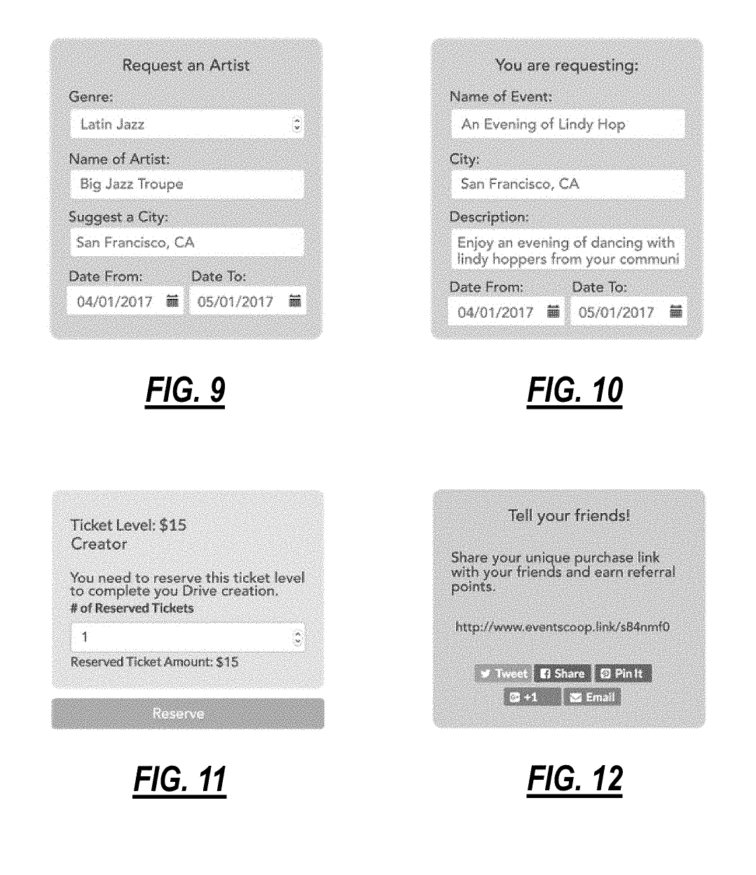

Referring to FIGS. 6-18, in various exemplary embodiments, various screen shots illustrate navigation through the event application on the social networking platform 12. FIG. 6 is a screen shot for requesting an artist. FIG. 7 is a screen shot for requesting an event. FIG. 8 is a screen shot for browsing through current drives, events pending confirmation, and confirmed events. FIG. 9 is a screen shot for requesting an artist. FIG. 10 is a screen shot subsequent to a request in FIG. 9 to confirm an event request. FIG. 11 is a screen shot of reserving tickets, i.e., making a pledge to a drive. FIG. 12 is a screen shot for sharing a newly created drive with friends via the social networking platform 12 or other social media.

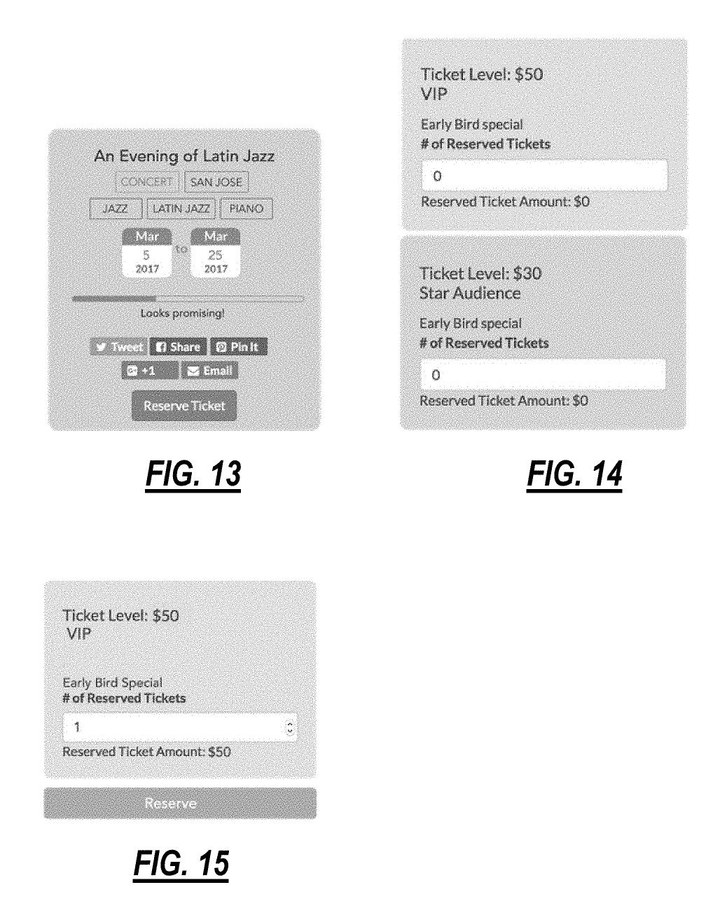

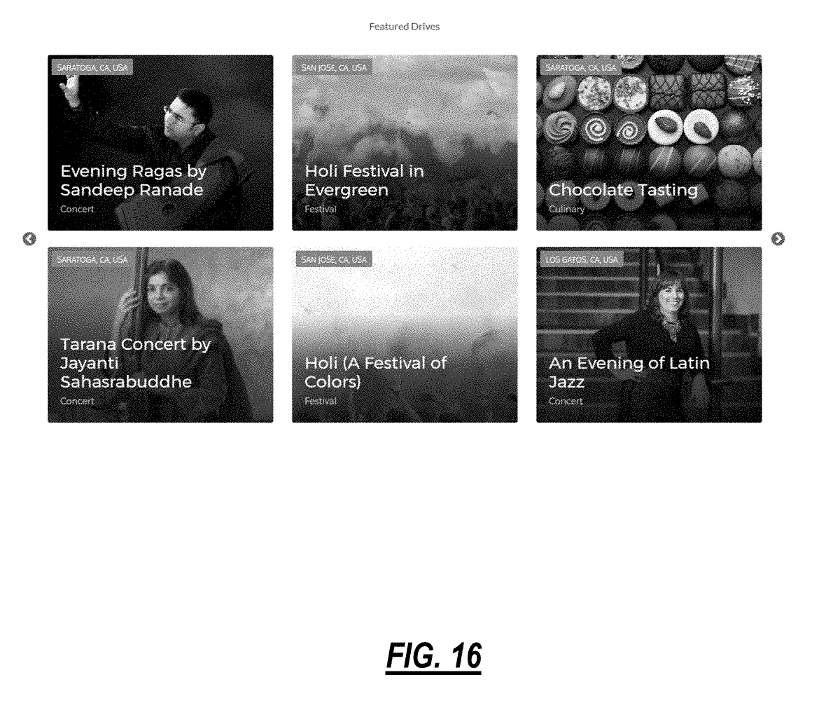

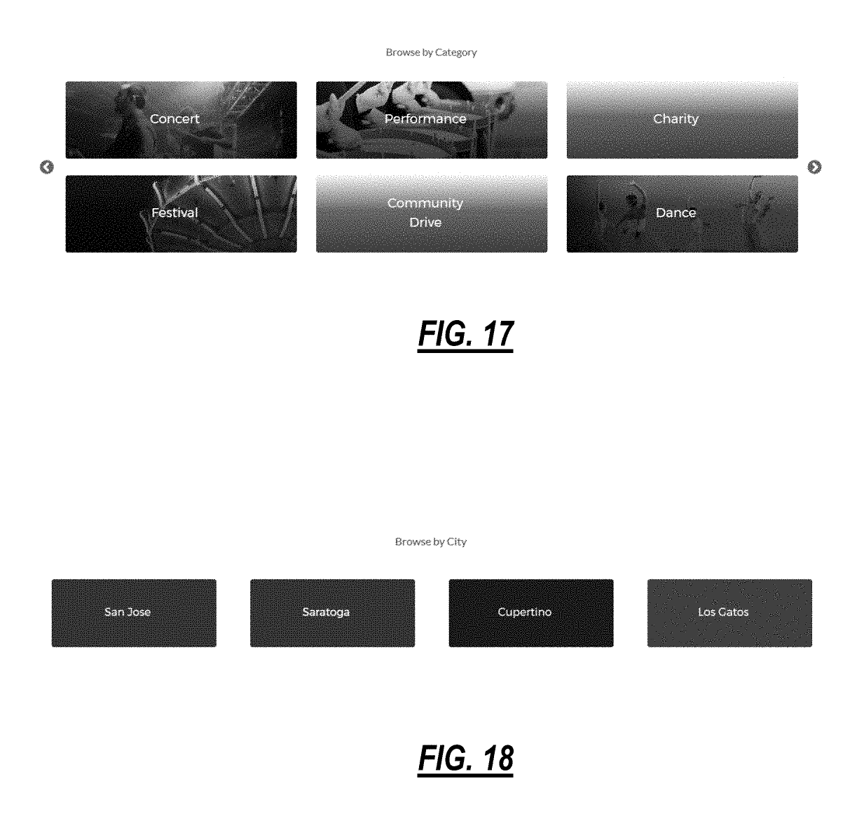

FIG. 13 is a screen shot showing a status of a drive. FIG. 14 is a screen shot for pledging support to the drive. FIG. 15 is a screen shot for reserving tickets for a drive. FIG. 16 is a screen shot of feature drives. FIG. 17 is a screen shot for browsing current drives, events pending confirmation, and confirmed events by category. FIG. 18 is a screen shot for browsing current drives, events pending confirmation, and confirmed events by location.

The various screen shots can be displayed and utilized via an app or browser on the user device 18. In FIG. 6, a user can click here to request an artist. This will take the user to a wizard (FIGS. 9-12) with some questions about the desired artist. The user specifies who they would like to see. For example, the user can search through a database associated with the event application to find the artist or enter details on the user's own. For example, artists can sign up with the event application to put themselves out there for possible events. Alternatively, any artist can be included and notified of the requested event. The user specifies where, e.g., city, town, zip code, etc., where they would like the artist to perform. If the user has a specific venue in mind, the user can specify it here. For dates, the user can provide a range of possible dates, preferably sometime in the future to allow other users to pledge their support.

Once entered, the user will be prompted to make a reservation to secure the request (FIG. 11). This enables the event application to confirm the commitment and work with the Artist to make the performance a reality. Note, the user is not charged at this point until the drive reaches its goal and becomes successful. A Drive is successful when it has the minimum number of reservations. The event application can send a notification when this occurs as well as providing real-time status.

Once the user has made a reservation, the user can see a referral link on the Thank You page (FIG. 12). This can also be emailed. The user can share the referral link with friends to earn referral rewards and make the drive a success. The drive can only succeed with participation in the process. The more friends that reserve tickets, the closer the drive gets to being a successful and scheduled event, and the closer the user is to seeing your favorite artist perform.

In FIG. 7, the user can click to request an event. This will take the user to a page with examples of all the events supported (FIG. 8). If the user does not see the one the user is looking for, the user can click on a custom option called ‘Your Event Idea.’ Clicking on any of the tiles on the Request an Event page takes the user to the respective wizard for that event (FIG. 13). For the events that the event application has templates available, the user will see the information already populated in the description field. The user can edit this information to add customization. The user can either stick with the default event description or change it to their liking.

The event application can have various drives in progress (FIG. 16). The user can discover them on the home page or browse by category, city, etc. The drive page tells the user pertinent information such as the available ticket levels, the range of dates when the event may happen, and also an indicator of what phase the drive is in. Some drives may have more than one ticket level to choose from. The differences are usually in the experience, seating or perks that they offer.

### Drive to Event

The concept of the drive gives the user the opportunity to live life on the user's terms. Again, currently, event creation is one-directional. Artists, venues and, event organizers create events, and fans consume whatever is available. The drive changes the paradigm of event creation by giving the fans a voice. There are many undiscovered artists as well as unique venues waiting to be discovered. The objective of the systems and methods is to empower users to bring the events they love to life. This is a way to demonstrate demand for an event idea without any risk.

A reservation (pledge) helps the artist and other professional event contributors see a real demand for the event. The event application can calculate a minimum goal of financial support required to make the event possible. The goal amount can be calculated based on the requested artist's rate and location, data on other similar events in the requested geography, venue costs, and other professional event contributor costs. The calculated goal amount may vary in each case and can be based on a variety of factors. Once this goal amount is reached, the event is confirmed.

In an exemplary embodiment, a user may withdraw a reservation or pledge up to a certain number of days before the drive period ends. After this point, a reservation is converted into a ticket. Once the drive's goal amount is achieved through reservations, the event is confirmed with details from the artist, venue and other professional event contributors. At this point, the drive becomes a confirmed event. There is no restriction on the number of drives a user may create and support. The user can keep track of the progress made by each drive on the event application.

In an exemplary embodiment, the event application can seek confirmation of a schedule from the artist, venue and any other professional contributors for the event once the drive reaches some threshold, including less than 100% of the minimum threshold. For example, once the drive has raised 80% of the goal, the event application can seek the confirmation. This schedule is published on the drive page and shared with all the supporters. If the schedule does not work for a user, that user can retract the reservation for a set time period, e.g., 3 days.

### Ticket Purchase Paradigm

The systems and methods change the architectural structure of conventional ticket purchasing platforms. Here, a user does not buy a ticket for a proposed event but rather pledges support for a ticket by ‘reserving a ticket’. A user makes a ticket reservation or pledge by specifying the number of tickets and providing a credit card or transfer of funds. In case of a credit card, the payment is deferred until the event is confirmed. The pledged support automatically becomes a ticket once the event is confirmed, i.e., reaches the threshold of support, has performer confirmation, and is scheduled for a venue. Once the event is confirmed and the user has not retracted his/her reservation (pledge) the credit card is charged. If a different form of payment is used such as Paypal or ACH transfer, where a deferred payment is not possible, the funds are considered to be held in a refundable account until the event is confirmed. The collected funds are applied to the event only when the event is confirmed and no retraction has taken place during the Drive period. If the user requests a retraction a refund is issued. Such approach is only enabled through the social networking platform 12 and the associated app for realizing the systems and methods. Without the social networking platform 12, the user devices 18, etc., such an architectural structure is impossible.

### Exemplary Server Architecture

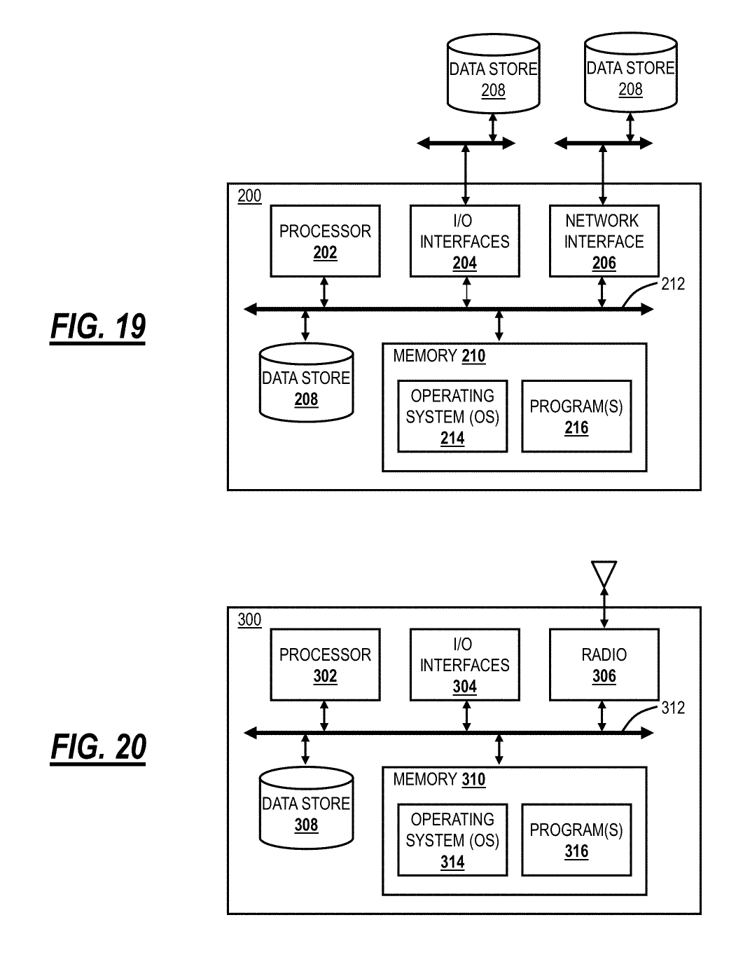

Referring to FIG. 19, in an exemplary embodiment, a block diagram illustrates a server 200 which may be used to host the social networking platform 12, the event application, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 19 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a central processing unit (CPU), an auxiliary processor among several processors associated with the server 200, a semiconductor-based microprocessor (in the form of a microchip or chip set), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components. User input may be provided via, for example, a keyboard, touchpad, and/or a mouse. System output may be provided via a display device and a printer (not shown). I/O interfaces 204 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 206 may be used to enable the server 200 to communicate on a network, such as the Internet 14. The network interface 206 may include, for example, an Ethernet card or adapter (e.g., 10BaseT, Fast Ethernet, Gigabit Ethernet, 10GbE) or a wireless local area network (WLAN) card or adapter (e.g., 802.11a/b/g/n/ac). The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200 such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable operating system (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

### Exemplary Mobile Device Architecture

Referring to FIG. 20, in an exemplary embodiment, a block diagram illustrates a user device 300, which may be used to access the social networking platform 12, the event application, etc. The mobile device 300 can be a digital device that, in terms of hardware architecture, generally includes a processor 302, input/output (I/O) interfaces 304, a radio 306, a data store 308, and memory 310. It should be appreciated by those of ordinary skill in the art that FIG. 20 depicts the mobile device 310 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a central processing unit (CPU), an auxiliary processor among several processors associated with the mobile device 300, a semiconductor-based microprocessor (in the form of a microchip or chip set), or generally any device for executing software instructions. When the mobile device 300 is in operation, the processor 302 is configured to execute software stored within the memory 310, to communicate data to and from the memory 310, and to generally control operations of the mobile device 300 pursuant to the software instructions. In an exemplary embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, barcode scanner, and the like. System output can be provided via a display device such as a liquid crystal display (LCD), touch screen, and the like. The I/O interfaces 304 can also include, for example, a serial port, a parallel port, a small computer system interface (SCSI), an infrared (IR) interface, a radio frequency (RF) interface, a universal serial bus (USB) interface, and the like. The I/O interfaces 304 can include a graphical user interface (GUI) that enables a user to interact with the mobile device 310. Additionally, the I/O interfaces 304 may further include an imaging device, i.e. camera, video camera, etc.

The radio 306 enables wireless communication to an external access device or network. Any number of suitable wireless data communication protocols, techniques, or methodologies can be supported by the radio 306, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; proprietary wireless data communication protocols such as variants of Wireless USB; and any other protocols for wireless communication. The data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another but can be accessed by the processor 302. The software in memory 310 can include one or more software programs, each of which includes an ordered listing of executable instructions for implementing logical functions. In the example of FIG. 20, the software in the memory 310 includes a suitable operating system (O/S) 314 and programs 316. The operating system 314 essentially controls the execution of other computer programs and provides scheduling, input-output control, file and data management, memory management, and communication control and related services. The programs 316 may include various applications, add-ons, etc. configured to provide end user functionality with the mobile device 300. For example, exemplary programs 316 may include, but not limited to, a web browser, social networking applications, streaming media applications, games, mapping and location applications, electronic mail applications, financial applications, and the like. In a typical example, the end user typically uses one or more of the programs 316 along with the social networking platform 12, the event application, etc.

### Event Creation Process

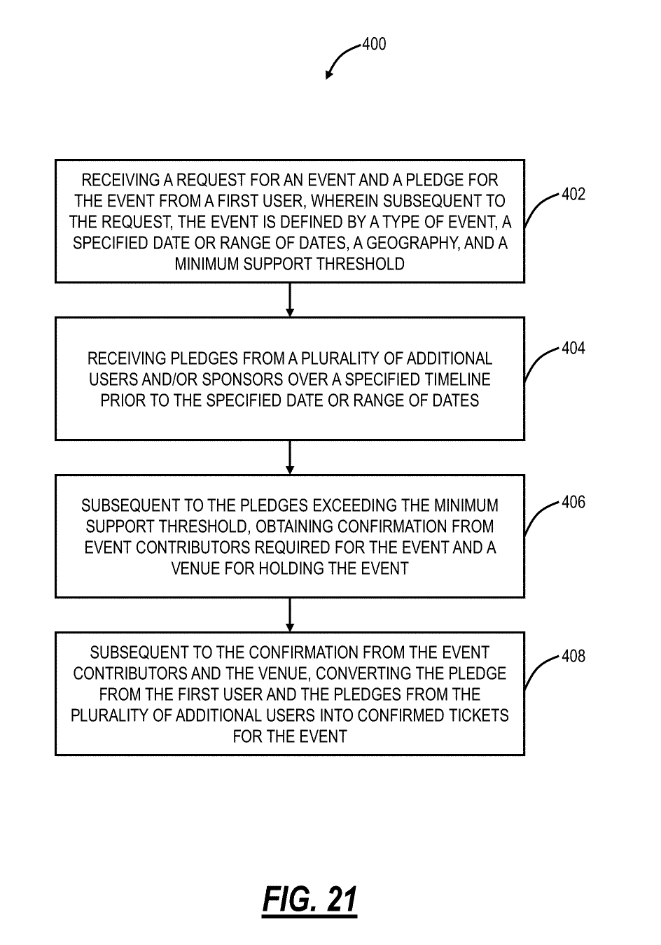

Referring to FIG. 21, in an exemplary embodiment, a flowchart illustrates an event creation process 400 implemented on the server 200 hosting an event application. The event creation process 400 includes receiving a request for an event and a pledge for the event from a first user, wherein subsequent to the request, the event is defined by a type of event, a specified date or range of dates, a geography, and a minimum support threshold (step 402); receiving pledges from a plurality of additional users over a specified timeline prior to the specified date or range of dates (step 404); subsequent to the pledges exceeding the minimum support threshold, obtaining confirmation from event contributors required for the event and a venue for holding the event (step 406); and, subsequent to the confirmation from the event contributors and the venue, converting the pledge from the first user and the pledges from the plurality of additional users into confirmed tickets for the event (step 408).

The event creation process 400 can further include, subsequent to the request, providing notification to the plurality of additional users via one or more social networking platforms. The event creation process 400 can further include, subsequent to the confirmation from event contributors and the venue, providing tickets to a second additional plurality of users for the event. The event can include any of a musical performance, an act, an art exhibit, a sporting event, a culinary event, and a social gathering. The event creation process 400 can further include, subsequent to the any of a failure to meet the minimum support threshold and a failure of the confirmation from event contributors and the venue, canceling the event and either not converting the pledges into actual charges or refunding the pledges. The minimum support threshold can be defined as an amount required to cover costs of the venue and the event contributors. The minimum support threshold can be defined as an amount close to costs of the venue and the event contributors.

The event application can be incorporated in or connected to a social networking platform, and wherein the first user and the plurality of additional users access the event application via one or more of a browser and an application executed on a user device. The event can be managed by the event application in three stages including a hopeful stage subsequent to the request and prior to the minimum support threshold, a confirmation pending stage subsequent to the minimum support threshold and prior to the confirmation from the event contributors and the venue, and a confirmed event subsequent to the confirmation from the event contributors and the venue. The venue can be selected based on a requestding process involving a plurality of venues, the first user, the plurality of additional users, and the event contributors.

In another exemplary embodiment, a server executing an event application for event creation by users includes a network interface communicatively coupled to the Internet; one or more processors communicatively to the network interface; and memory storing instructions that, when executed, cause the one or more processors to receive a request for an event and a pledge for the event from a first user, wherein subsequent to the request, the event is defined by a type of event, a specified date or range of dates, a geography, and a minimum support threshold; receive pledges from a plurality of additional users over a specified timeline prior to the specified date or range of dates; subsequent to the pledges exceeding the minimum support threshold, obtain confirmation from event contributors required for the event and a venue for holding the event; and, subsequent to the confirmation from event contributors and the venue, convert the pledge from the first user and the pledges from the plurality of additional users into confirmed tickets for the event.

### Professional Users

The foregoing descriptions illustrated events with respect to the users 16 of social networking platforms, but those skilled in the art will recognize a similar approach can be implemented with so-called professional users, i.e., advertisers, event organizers, vendors, etc. The professional users can use event creation process 10, 400 in a similar manner to provide their associated services. For example, the event creation process 10, 400 can include an additional step of receiving pledges from a plurality of professional users including advertisers, event organizers, and vendors that want to sell goods at the event over a specified timeline prior to the specified date or range of dates. Also, the professional users can implement the event creation process 10, 400 separately from the users 16.

It will be appreciated that some exemplary embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application Specific Integrated Circuits (ASICs), in which each function or some combinations of certain of the functions are implemented as custom logic or circuitry. Of course, a combination of the aforementioned approaches may be used. For some of the exemplary embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various exemplary embodiments.

Moreover, some exemplary embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various exemplary embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. An event creation method implemented on a server hosting an event application, the event creation method comprising:
receiving a request for an event and a pledge for the event from a first user, wherein subsequent to the request, the event is defined by a type of event, a specified date or range of dates, a geography, and a minimum support threshold;
receiving pledges from a plurality of additional users over a specified timeline prior to the specified date or range of dates;
subsequent to the pledges exceeding the minimum support threshold, obtaining confirmation from event contributors required for the event and a venue for holding the event; and
subsequent to the confirmation from the event contributors and the venue, converting the pledge from the first user and the pledges from the plurality of additional users into confirmed tickets for the event.

2. The event creation method of claim 1, further comprising:
subsequent to the request, providing notification to the plurality of additional users via one or more social networking platforms.

3. The event creation method of claim 1, further comprising:
subsequent to the confirmation from event contributors and the venue, providing tickets to a second additional plurality of users for the event.

4. The event creation method of claim 1, wherein the event comprises any of a musical performance, an act, an art exhibit, a sporting event, a culinary event, and a social gathering.

5. The event creation method of claim 1, further comprising:
subsequent to the any of a failure to meet the minimum support threshold and a failure of the confirmation from event contributors and the venue, canceling the event and either not converting the pledges into actual charges or refunding the pledges.

6. The event creation method of claim 1, wherein the minimum support threshold is defined as an amount required to cover costs of the venue and the event contributors.

7. The event creation method of claim 1, wherein the minimum support threshold is defined as an amount close to costs of the venue and the event contributors.

8. The event creation method of claim 1, wherein the event application is incorporated in or connected to a social networking platform, and wherein the first user and the plurality of additional users access the event application via one or more of a browser and an application executed on a user device.

9. The event creation method of claim 1, wherein the event is managed by the event application in three stages comprising a hopeful stage subsequent to the request and prior to the minimum support threshold, a confirmation pending stage subsequent to the minimum support threshold and prior to the confirmation from the event contributors and the venue, and a confirmed event subsequent to the confirmation from the event contributors and the venue.

10. The event creation method of claim 1, wherein the venue is selected based on a request process involving a plurality of venues, the first user, the plurality of additional users, and the event contributors.

11. The event creation method of claim 1, further comprising:
receiving pledges from a plurality of professional users comprising advertisers, event organizers, and vendors that want to sell goods at the event over a specified timeline prior to the specified date or range of dates.

12. A server executing an event application for event creation by users, the server comprising:
a network interface communicatively coupled to the Internet;
one or more processors communicatively to the network interface; and
memory storing instructions that, when executed, cause the one or more processors to
receive a request for an event and a pledge for the event from a first user, wherein subsequent to the request, the event is defined by a type of event, a specified date or range of dates, a geography, and a minimum support threshold;
receive pledges from a plurality of additional users over a specified timeline prior to the specified date or range of dates;
subsequent to the pledges exceeding the minimum support threshold, obtain confirmation from event contributors required for the event and a venue for holding the event; and
subsequent to the confirmation from event contributors and the venue, convert the pledge from the first user and the pledges from the plurality of additional users into confirmed tickets for the event.

13. The server of claim 11, wherein the memory storing instructions that, when executed, further cause the one or more processors to
subsequent to the request, provide notification to the plurality of additional users via one or more social networking platforms.

14. The server of claim 11, wherein the memory storing instructions that, when executed, further cause the one or more processors to
subsequent to the confirmation from event contributors and the venue, provide tickets to a second additional plurality of users for the event.

15. The server of claim 11, wherein the event comprises any of a musical performance, an act, an art exhibit, a sporting event, a culinary event, and a social gathering.

16. The server of claim 11, wherein the memory storing instructions that, when executed, further cause the one or more processors to
subsequent to the any of a failure to meet the minimum support threshold and a failure of the confirmation from event contributors and the venue, cancel the event and either not converting the pledges into actual charges or refunding the pledges.

17. The server of claim 11, wherein the minimum support threshold is defined as an amount required to cover costs of the venue and the event contributors.

18. The server of claim 11, wherein the minimum support threshold is defined as an amount close to costs of the venue and the event contributors.

19. The server of claim 11, wherein the event application is incorporated in or connected to a social networking platform, and wherein the first user and the plurality of additional users access the event application via one or more of a browser and an application executed on a user device.

20. The server of claim 11, wherein the event is managed by the event application in three stages comprising a hopeful stage subsequent to the request and prior to the minimum support threshold, a confirmation pending stage subsequent to the minimum support threshold and prior to the confirmation from the event contributors and the venue, and a confirmed event subsequent to the confirmation from the event contributors and the venue.
